(19) United States
(12) Patent Application Publication
(10) Pub. No.: US 2012/0133234 A1
(43) Pub. Date: May 31, 2012

(54) ELECTRICAL SPHERICAL GENERATOR OF MAGNETIC INDUCTION

(76) Inventor: Pedro Da Costa Balas Ferreira, Lisbon (PT)

(21) Appl. No.: 13/256,939

(22) PCT Filed: Mar. 16, 2010
(86) PCT No.: PCT/PT10/00012

§ 371 Date: Feb. 21, 2012

(30) Foreign Application Priority Data
Mar. 16, 2009 (PT) 104442

(51) Int. Cl. H02K 1/06

(52) U.S. Cl. 310/179

(57) ABSTRACT

A spherical generator comprises a permanent magnet sphere (4) which center of mass is shifted from the geometrical centre. A curved coil system (1) forming a sphere movably surrounds the permanent magnet sphere (4).

Nowadays, almost all electric generators are using fossil fuels (except generators that take advantage of renewable energy, such as the generators of wind mills). This generators are only capable to use only one energy source and are they are not scalable, for instance, the same type of generator can not be sized down to became transportable by one person to use the generated electricity on a phone, or on a computer, on a watch, on a MP3 player, etc. These generators can not be sized up so as to produce large amounts of energy justifiable, for example, sufficient electricity for a building, for a boat, for a car, etc . . . And still is expensive. All generators that exist today were designed to operate with a magnetic inductor in a single rotating shaft, which is highly inefficient because only produces electricity on one axis not being able to capture oscillations and other external movements in any direction, also the dissipated energy is very high. These generators are very restrictive.

Due to the necessity of the existence of an electric generator that is clean, efficient, that operates at any built scale, which would capture several types of renewable energy and still can be incorporated into any electrical system to function as an electrical source in order to take advantage of kinetic energy and transform in electrical energy, then comes up, the present invention is characterized as a spherical machine generates electrical energy by magnetic induction, standing in the field of electrical engineering and refers to a generator that works primarily with the rotation or movement of a sphere incrusted with permanent magnets (4) to magnetize the outermost coils (1 and 3), which in turn, they generate electric current in their wire, according to Faraday's Law of Electromagnetic Induction.

For better perception the concept is represented schematically in the figure below:

The Electric Spherical Generator consists of curve coils (1 and 3) (represented by the number 3 in the FIG. above), a sphere containing a liquid (represented by number 2 in the FIG. above) and a magnetic sphere (4) (represented by the number 1 in FIG. above), centered within the liquid. This magnetic sphere (4) has an internal pendulum to interact with gravity. Thus, this sphere remains relatively fixed when there is movement or rotation of the external parts, and there is thus a relative movement and rotation between the magnetic field and the coils, as shown below, producing electricity.

Representation of the magnetic flow field generated by the magnetic sphere relative to the position of the coils:

Note that the existence of a liquid between the sphere incrusted with permanent magnets (4) and the coils (1 and 3) serves to greatly reduce the friction between them, the liquid can be replaced by a gas, a system of bearings or even for a magnetic levitation system, it should be noted also that only electrical energy is generated when there is rotation (or movement) on between the magnetic sphere (sphere incrusted with permanent magnets (4)) and the coils (1 and 3), hence it is important to reduce or even cancellation of friction.

The present invention solves the limitations observed in conventional generators. Absorbs all the external movement and rotation for electric generation, can be built in any size, and the electricity produced is proportional to its size. Can be incorporated into any electrical system that provides the movement or rotation on the sphere incrusted with permanent magnets (4). It produces electricity from the kinetic energy, therefore not consuming any kind of fuel for electricity generation. But mostly, the great advantage is that there are numerous applications that this invention provides, for example, this generator can be adapted to a platform designed to capture wind power, solar, hydro or even the use of these and other kinetic energies, simultaneously. Finally, this machine becomes highly effective for holding the resulting kinetic energy on all axes of rotation generating electrical power at all points of the coils. Whereas the conventional simplified generator produces electrical power just at two points in the coil, the present invention produces at all points of the spherical surface of the constituent group of coils (1 and 3).

The present invention is described below in detail, but not limited to the examples, by way of a preferred embodiment, represented in the attached drawings in which:

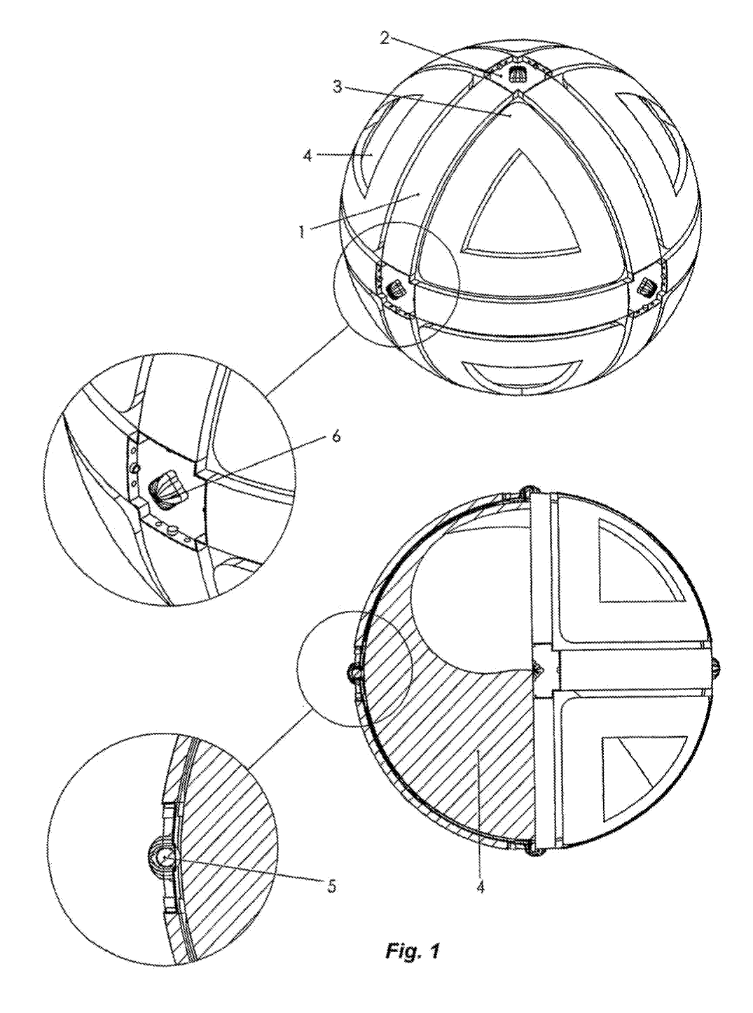

FIG. 1 is a representation of the present invention that contains two views of the same Electric Spherical Generator. The first is a perspective view and the second is a side view that is represented without one of the halves. Both views, belonging to FIG. 1 depicts a schematic and simplified implementation of a machine according to the invention described, and

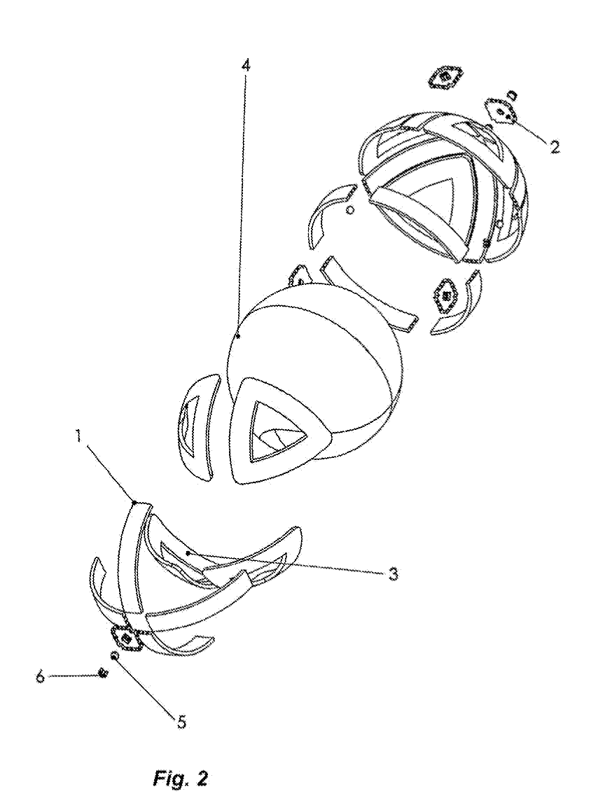

FIG. 2 is a schematic, simplified, exploded perspective of the same realization of the same machine represented in FIG. 1.

### DESCRIPTION OF PREFERRED EMBODIMENT

With reference to the figures, it will be now be described a preferred embodiment of the invention, in which the machine consists of a set of organs represented at those figures, mounted as described below.

The outer support structure (not represented), modifiable and adaptable for different applications and environments, serves to house inside it, the spherical generator machine, also presented here as “this invention”. This structure is described also as a protection system of this invention.

Each arm wrapped in cooper wire (1), also described as curve coil, is characterized as a structural piece with an arc shape surrounded by the turns of the cooper wire and inside of this arc shaped structure there is a metal core to contribute for a high magnetic permeability. Each end of a curve coil (1) is connected with a respective joint (2).

Each joint (2) unifies four curve coils (1) connecting the ends of the wire of the coils (1) together in order to connect every coil in series, so that the twelve curves coils are connected together. This joint also has the function of holding the ball bearing (5) thereof, enclosed with a small led (6).

The sphere with incrusted magnets (4) is a sphere of material preferably plastic and homogeneous, in order to condense the center of mass in a different point than the geometrical center of the sphere, to make the sphere as static as possible relative to the ground. It has to be this way to proportionate the relative movement between the sphere with incrusted magnets (4) and the coils. The sphere with incrusted magnets (4) has its magnets preferably distributed according to a uniform pattern in order to produce the magnets, in one shape, for example, a pattern of 120 triangles, involving the entire sphere. These, regardless of their distribution, maintain a small space between them to maintain their potential energy. This sphere with incrusted magnets (4) is enclosed within the sphere formed by the twelve curve coils (1) that are connected by six joints (2), in turn, this joints holds the six ball bearings (5) enclosed with the aid of the respective led (6). Subsequently, the triangular coils (3) are placed in the spaces left to fill by the curve coils (1). This triangular coils (3) are supported with the help of the support and protective structure (not represented) described above as the cover of the entire machine.

With the rotation in any direction the group of parts consisting of the support structure (not represented), along with the curve coils (1) interconnected by the joints and the triangular coils (3), the sphere incrusted with permanent magnets (4), due to inertia and the fact that the center of mass is offset from the geometric center of the sphere, it remains fixed (as shown in the schematic FIG. above), allowing relative motion between the magnetic field generated by permanent magnets and the coils (1 and 3), creating electric current at all points of the coils.

The present invention may undergo several changes concerning the size, number and shape of the coils, the system of bearings, liquid, gas or magnetic levitation, because it may have many applications and also the energy produced is proportional to its size; there may also be changes at the structural level, so as to produce more power with less movement or rotation (for low frequencies), with different solutions for the group of coils (1 and 3), joints (2), that can be created in other ways and with different electrical connections, while maintaining the spherical shape of the present invention, for example, it can be created devoid of core coils and the wire can be wrapped around the sphere incrusted with permanent magnets (4), leaving room for that it can roll, another example is the use of plates to replace the wire of coils so as to save space and increase the number of coils as well; may also be changes at the level of support of the sphere incrusted with permanent magnets (4), it can be supported by a liquid (as mentioned about the fact that reduces the friction), magnetic levitation, gas or any other case with the possible removal of bearing balls (5); The sphere incrusted with magnets (4) can be modified by replacing part of its body mass by a weight of a heavy material and thus shifting the center of mass to one end, to preserve the oscillation effect, and with the space left can be filled with an electronic system, electrified with the energy produced by the outer spherical generator, for example a flash disk with an antenna, or another system of electricity generation, reducing the total weight of machinery; may also lose one or two axes of rotation allowing the rotation of reels in one axis (ideal for one-way movements); In the case of applying the liquid to reduce friction may be applied convection currents in order to allow movement for the magnetic sphere (4) or even the coils (1 and 3). In the same case for the application of fluid to reduce friction, can be used a magnetic liquid, without exclusion of the magnetic sphere (4), in order to increase the magnetic field or even increase the relative movement and rotation between the coils and the magnetic field; Can also replace the air present in the machine for lighter gases, or vacuum; Can even add layers of coils and/or bearing systems, in order to get more kinetic energy to produce even more electricity.

The present invention may undergo several changes that allow maximum efficiency of electricity production, depending on the desired application and use. This invention can be subject to multiple applications including its implementation in a portable charger in order to produce electrical energy due to external movements caused by the person holding the device in order to latter charge electronic devices; It stores energy in the form of chemical energy stored in internal battery for when you want to charge the external device in question, such as mobile phones, mp3 players, laptops, and others. Another application is the production of this invention on a larger scale (e.g., 2 meters diameter), mounting it on a floating platform in order to harness the energy of the waves to generate electricity, it can be adapted in order to take advantage of wind and solar energy as well as the use of any other energy source that enables the movement and relative rotation between the coils (1 and 3) and the sphere incrusted with magnets (4) to produce electricity and can be also applied in whatever land or water. Yet another application is the production of the present invention on a smaller scale (e.g. using nanotechnology) so that it can be installed on a system with a battery and mounted on a portable electronic device, in order to fully empower the unit, just with oscillations taken by handling. The applications of this invention are unlimited and can also be used to generate electricity and serve as a source of energy for motor vehicles, motorcycles, boats, airplanes and other vehicles. This application is very advantageous because it enables the empowerment of any mobile system without having to ever be charged externally, for the electricity used in the electrification of the system is generated by the present invention by converting kinetic energy into electricity.

Changing and fixing all these parameters, allows the adjustment of the machine to a variety of applications, uses and resources, as explained above. Note that even if all these changes are implemented, the present invention will never abandon its concept of Electric Spherical Generator of Magnetic Induction. Since some of these modifications are designed to maximize the energy conversion, thus increasing the production of electricity, such as:
Its dimensional structure. For the energy produced is proportional to its size;
Increasing the magnetism of the sphere incrusted with magnets (4), with proportional increase of magnets and/or change of shape, number and distribution of these;
Replacement of the ball bearings by a system comprising the same sphere of magnets but surrounded by a ball conditioning a liquid that fills the spacing between the sphere incrusted with magnets (4) and the new container sphere. Thus enables the sphere incrusted with magnets rolling, possibly more efficient and with less friction, keeping all the main characteristics of the generator;
Changing the shape of the outer structure (formed by the twelve curve coils (1), the six joints (2) and the eight triangular coils (3)) in order to take in all the available magnetic field;
Amendment of quality, quantity and sectional area of the wire used in the coils;
Use of the space available inside the sphere of magnets (4) with the introduction of an electronic system (e.g., a system composed of a Flash disk connected to an antenna in conveying data supplied by the same generator);
Addition of one or more circuits within the magnetic field, mobile or static;
Installation of the present invention on a floating platform in order to absorb the kinetic energy spent by the movement of waves on any water plan in order to generate electricity, and may be added later other features that permit the use of wind, solar, thermal, sound and tidal energies;
Use of the present invention to assist in producing electricity from other forms of renewable energies;
Installation of this invention in a terrestrial platform in which it is possible to produce electricity and it is also possible to introduce all the changes mentioned here;
Installation of the present invention, with the possibility of introducing all the changes described above, in an electric system as the primary or secondary power source;
Necessary modifications or no to the introduction of the present invention in a portable charger for portable electronic devices with different interfaces, one for each device to charge (e.g., laptops, MP3 players, cell phone, etc.);
Necessary modifications or no to the application of the present invention in electrical systems, motor vehicles, boats, airplanes, satellites and other orbital systems, rockets, missiles, torpedoes, spaceships, rockets, buildings, machinery, trains, prostheses, clothing, footwear, accessories, fabrics, construction, and every object or system that as relative motion;
Installation of the present invention combined with other modified versions of the same;
Introduction of a sliding magnet the coiled structure of the present invention that allows a greater use of magnetism on the coils, therefore generating more electricity;
Installation of a generator system within the sphere incrusted with magnets (4) of the present invention;
Use of thermal energy to create convection currents in order to move the sphere incrusted with magnets, and therefore moving the magnetic field generated by the sphere incrusted with magnets and passing by the coils generates electric current by magnetic induction;
Use of a magnetic liquid in order to increase the magnetic field and their relative movement and rotation between the coils and the magnetic field;
Installation of the present invention with a combination of some modifications mentioned here or the introduction of all the changes described in this invent.
Lisbon, 15 Mar. 2010

1-13. (canceled)

14. A machine that captures oscillations and other movements in any axis of coordinates in form of kinetic energy converting it for electricity generation, comprising a sphere with the center of mass offset from the its geometric center incrusted with permanent magnets, enclosed in a bearing system composed of six ball bearings each enclosed by a lid, and six joints each having four curve coils that in turn are formed by winding conductive wire around a metallic core or they can be devoid of core and the wire can be replaced by metallic plates placed around the sphere incrusted with permanent magnets, thus forming a spherical frame of curve coils all connected in series with eight triangular coils filling the spaces left free by the same spherical frame, taking in the rest of the magnetic field generated by the permanent magnets from the sphere incrusted with permanent magnets; this machine captures oscillations and other movements and converting them into electrical energy as follows: The Electric Spherical Generator of Magnetic Induction has two parts, the stator and rotor, the stator part is the sphere with the center of mass offset from the geometric center incrusted with permanent magnets and the rotor consists of the remaining pieces with special attention to the curve coils and triangular coils, all fixed and interconnected to form a sphere of coil around the rotor; the sphere incrusted with permanent magnets has its center of mass shifted from the geometric center, this way interacting with the gravity fixing it relatively while the rotor rotates freely around the stator, driven by any action of rotation or other movement outside the rotor, without much friction between the sphere incrusted with permanent magnets and the bearing balls that belongs to the rotor, that keeps the sphere incrusted with permanent magnets to maintain the position although it can rotate freely, this way, the sphere incrusted with permanent magnets generates a magnetic field and the coils, belonging to the rotor, move freely around the stator, by the law of electromagnetic induction, this field will magnetize the curve coils and triangular coils generating electrical energy in all parts of the conductive wire of those coils, connected in series forming one circuit.

15. The electric generator of magnetic induction, according to claim 15, characterized by having a spherical frame composed by twelve curve coils, interconnected by joints that unifies the pieces and serves as a framework for handling ball bearings.

16. The electic generator according to claim 14, characterized by the deviation of the natural center of mass of the sphere incrusted with permanent magnets is amended by the introduction of objects and/or electronic and mechanical systems inside.

17. The electric generator according to claim 14, characterized by having coils devoid of core and their conductive wire is wrapped around the sphere incrusted with permanent magnets, leaving room for it to roll.

18. The electric generator according to claim 14, characterized by having a spherical container, between the sphere incrusted with magnets and the coils and bearings system, which contains a liquid or a gas that leads to the sphere incrusted in permanent magnets to reduce its friction during the movement and/or rotation.

19. The electric generator according to claim 1, characterized by using a magnetic liquid, contained within the spherical container of liquid or gas, in order to increase the magnetic field generated by the sphere incrusted with permanent magnets.

20. The electric generator according to claim 1, characterized by having convection currents applied to the liquid or gas so as to move the magnetic sphere and coils.
